(19) United States
(12) Patent Application Publication
(10) Pub. No.: US 2012/0060464 A1
(43) Pub. Date: Mar. 15, 2012

(54) SYSTEMS, METHODS AND APPARATUS FOR PROPULSION

(76) Inventors: James Robert Grote, Mojave, CA (US); Thomas Clayton Pavia, Mojave, CA (US)

(21) Appl. No.: 12/472,371

(22) Filed: May 26, 2009

Related U.S. Application Data
(63) Continuation-in-part of application No. 11/782,631, filed on Jul. 24, 2007, now Pat. No. 7,997,510.

(51) Int. Cl. F02K 9/64

(52) U.S. Cl. 60/206

(57) ABSTRACT

In some implementations a propulsion system includes a thrust chamber comprised of a combustion chamber and an expansion nozzle. The thrust chamber has an interior and exterior surfaces and a main propellant injector mounted to the thrust chamber to inject an oxidizer and a fuel into the interior of the thrust chamber. The total fluid flowing to the rocket engine is compromised of oxidizer, fuel, internal film coolant, and external convective coolant. The internal film coolant ranges from about 1% to about 10% of the total fluid. Reduced coolant tubing circumscribes the exterior of the thrust chamber to circulate an external convective coolant, and a nozzle film coolant manifold mounted to the expansion nozzle injects the external convective coolant onto the interior wall of the expansion nozzle, the external convective coolant being about 1% to about 10% of the total fluid flow to the thrust chamber.

### RELATED APPLICATION

This disclosure claims the benefit of U.S. Provisional Application Ser. No. 60/833,198 filed Jul. 24, 2006 under 35 U.S.C. 119(e). This disclosure claims priority under 35 U.S.C. 120 to copending U.S. application Ser. No. 11/782,631, filed Jul. 24, 2007 entitled “SYSTEMS, METHODS AND APPARATUS FOR PROPULSION.” This disclosure claims the benefit of copending U.S. Provisional Application Ser. No. 61/128,761 filed 23 May 2008 under 35 U.S.C. 119(e).

### FIELD

This disclosure relates generally to propulsion systems, and more particularly to rocket engines.

### BACKGROUND

In conventional liquid propellant rocket engines, a main propellant injector sprays liquid propellants into a combustion chamber, where the propellants are burned. The burned propellants expand in an expansion nozzle, where the propellants increase in velocity and produce thrust. A thrust chamber encompasses both the combustion chamber and the expansion nozzle.

One of the propellants (usually the fuel) flow through coolant tubes or channels in the thrust chamber. The relatively cool propellant flowing in the coolant tubes or channels cools the thrust chamber and prevents the thrust chamber from failing or melting. These conventional fluid cooled engines are typically called regeneratively cooled engines because the engine uses one of the main propellants to cool the thrust chambers. Examples of regeneratively cooled engines are the Space Shuttle's SSME engine and the Apollo program's F-1 engine.

The thrust chambers of conventional regeneratively cooled engines include large numbers of individual coolant tubes, perhaps dozens to as high as one thousand coolant tubes, and above. The coolant tubes are brazed or welded together side-by-side like asparagus, or if cooling channels are used the channels are fabricated from large, thick metal shells. The cooling system of the thrust chamber is very often a large part of a rocket engine's procurement expense and requires long lead time to manufacture.

### BRIEF DESCRIPTION

The above-mentioned shortcomings, disadvantages and problems are addressed herein, which will be understood by reading and studying the following specification.

In some implementations a propulsion system includes a thrust chamber having a combustion chamber and an expansion nozzle mounted to and being part of the thrust chamber and having an interior and having an exterior, a main propellant injector mounted to the thrust chamber to inject main propellant fluids into the interior of the thrust chamber, the main propellants include an oxidizer and fuel. An internal film coolant is also injected into the thrust chamber interior and the internal film coolant can be injected either from the main propellant injector or from a separate injector for the internal film coolant. The proportion of internal film coolant flowrate typically ranges but is not limited to about 1% to about 5% of the total fluid flowing through and/or into the thrust chamber which includes oxidizer, fuel, and cooling fluids. The total amount of fluid flowing through and/or into the rocket engine thrust chamber 102 is referred to as “the fluid.” Coolant tubing circumscribes the exterior of the thrust chamber to circulate an external convective coolant, and a film cooling injector mounted to the expansion nozzle is operable to inject the external convective coolant onto the interior wall of the expansion nozzle as a nozzle film coolant, the external convective coolant being about 2.75% of the fluid but can be other values than 2.75%. The system can operate at acceptably low temperatures while having acceptably high amounts of thrust, in which the thrust chamber can be made of thin walls of conventional metals with simple coolant tube construction.

In one aspect, a thrust chamber shell 132 having a wall of a thickness of between about 0.010 inches and about 0.50 inches, but is usually between 0.030 and 0.10 inches. This thickness range does not include the thickness of any stiffening ribs or other hardware formed into or mounted to the thrust chamber shell 132.

In another aspect, a propulsion system includes a cooling system and a main propellant injector that is operably coupled to a thrust chamber, the main propellant injector being operably independent from the cooling system.

In yet another aspect, a cooling system includes cooling tubes consisting of a few coolant tubes circumscribing an exterior of the thrust chamber and operable to circulate an external convective coolant.

In still another aspect, wherein a thrust chamber comprises of a metal shell 132 selected from a group consisting of but not limited to aluminum, stainless steel, alloy steel, copper, an austenitic nickel-based superalloy, alloys, metal composites, plastic composites thereof and mixtures thereof were applicable.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a cross section side-view block diagram of an overview of a propulsion apparatus with a thrust chamber cooling system;

FIG. 2 is an example cross section top-view block diagram of a film coolant injector apparatus having film coolant orifices, according to an implementation;

FIG. 3 is an isometric block diagram of a thrust chamber that shows a swirling flow of a layer of internal film coolant along the thrust chamber inside wall, according to an implementation;

FIG. 4 is a cross section side-view block diagram of a propulsion apparatus, according to an implementation having a having a thrust chamber cooling system with a single-walled dome and spiraling cooling tubes on the dome;

FIG. 5 is a cross section side-view block diagram of propulsion apparatus including a flat-faced injector and a fluid-cooled thrust chamber, according to an implementation;

FIG. 6 is a flowchart of a method to cool a rocket engine according to an implementation;

FIG. 7 is a block diagram of an engine control computer in which different implementations can be practiced;

FIG. 8 is a block diagram of a data acquisition circuit of an engine control computer in which different implementations can be practiced;

FIG. 9 is a block diagram of a rocket engine cooling system using a dual shell thrust chamber, according to an implementation; and

FIG. 10 is a block diagram of a thrust chamber of a rocket engine cooling system using a dual shell thrust chamber, according to an implementation.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into six sections. In the first section, a system level overview is described. In the second section, apparatus of implementations are described. In the third section, implementations of methods are described. In the fourth section, hardware and the operating environments in conjunction with which implementations may be practiced are described. In the fifth section a dual-shell (or double-wall) implementation is described. Finally, in the sixth section, a conclusion of the detailed description is provided.

### System Level Overview

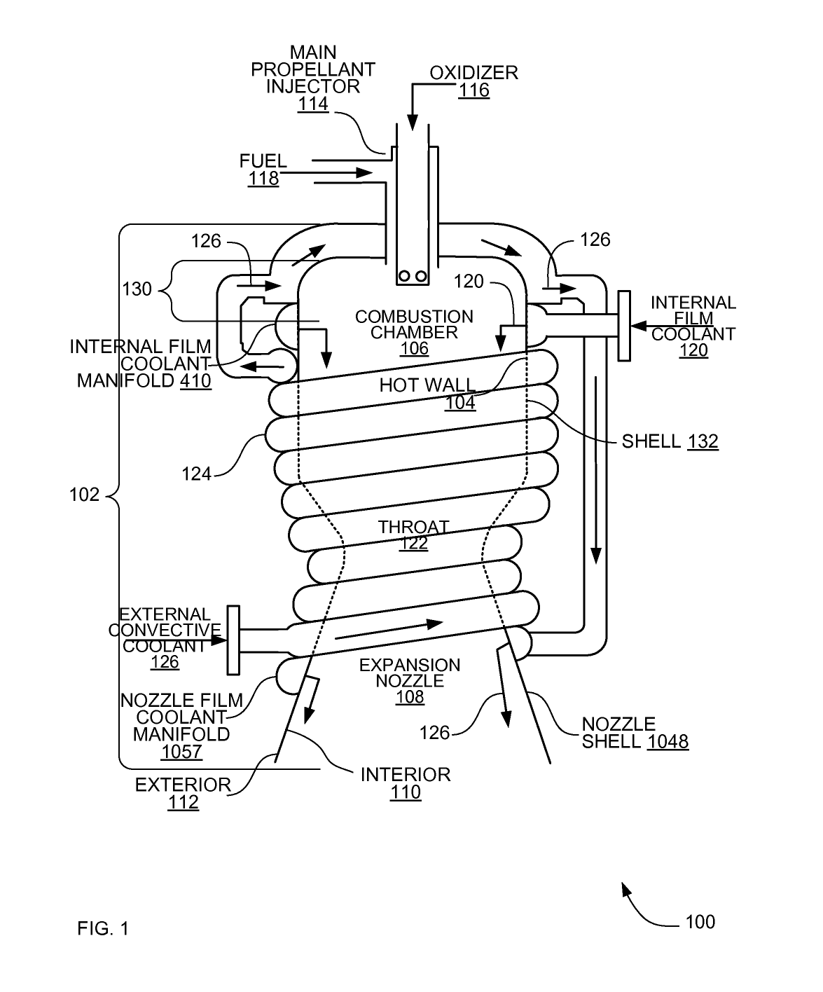

FIG. 1 is a cross section side-view block diagram of an overview of a propulsion system 100 with a unique thrust chamber cooling system. Propulsion system 100 solves the need in the art for a rocket engine cooling system that does not require extensive machining, custom tooling and fabrication custom processes.

The cooling system in FIG. 1 can be considered as a baseline design for the subsequent figures. No implementations are limited to the baseline design and other variations and options can be implemented, but the baseline design demonstrates basic traits and aspects.

The baseline design consists of a pintle main propellant injector 114 and a thrust chamber 102 that consists of a combustion chamber 106 and an expansion nozzle 108. The thrust chamber 102 is fabricated with a sheet metal Inconel® alloy shell 132. The shell 132 is a thin metal structure that forms the most significant, but not only, structural element that forms the thrust chamber.

In some implementations, a spiraled copper coolant tube(s) 124 is brazed to the outside of a portion of the thrust chamber shell 132. The coolant tube(s) 124 begins wrapping spirally around the thrust chamber 102 starting at the expansion nozzle 108 area ratio of 4 and continues upward to meet with and cool the double-shell thrust chamber dome 130.

The baseline design rocket engine is a pressure-fed, liquid propellant rocket engine with a combustion chamber pressure of about 300 pounds per square inch (psia). The main propellants are liquid oxygen and jet fuel. Water is the external convective coolant 126 and jet fuel is the internal film coolant 120 injected onto the hot wall 104 of the combustion chamber 106. To cool the thrust chamber 102 the water external convective coolant 126 flows through the coolant tube(s) 124 to cool the bulk of the thrust chamber then the water flows between the two walls of the double-shell dome 130 to cool the dome 130 then the water is directed downward through a tube to the expansion nozzle where the water is injected onto the interior wall 110 of the expansion nozzle 108. As seen in FIG. 1 the lower portion of the expansion nozzle 108 is simply a single wall sheet metal shell and this portion of the expansion nozzle 108 is called the nozzle shell 1048. After cooling a portion of the thrust chamber 102 through the coolant tube(s) 124 the external convective coolant 126 cools the nozzle shell 1048 as a nozzle film coolant.

The exterior surface of the entire thrust chamber shell 132 is referred to as the “exterior” 112. The inside wall 104 or “hot wall” 104 is the inside wall (i.e. the wall adjacent to the combustion flames) of that portion of the thrust chamber 102 that is cooled by the external convective coolant 126 flowing through coolant tube(s) 124. The “interior 110” refers to the inside wall of the nozzle shell 1048.

In FIGS. 1, 4, 5, and 10 the internal film coolant manifold 410 and the nozzle film coolant manifold 1057 double in function as both manifolds for distributing film coolant and as injectors for injecting the film coolant onto the inner wall of the thrust chamber 102 at various locations. For the injection of film coolant, the terms “manifold” and “manifold/injector” are equivalent and interchangeable.

The thrust chamber 102 is the portion of the rocket engine that is downstream of a main propellant injector 114. In some implementations, the main propellant injector 114 is a pintle injector as shown in FIG. 1. The main propellant injector 114 is operably coupled to the thrust chamber 102. The main propellant injector 114 is also operable to inject the main propellants into the interior volume of the thrust chamber 102 and in some implementations an internal film coolant 120 is injected onto the hot wall 104 and in some implementations the internal film coolant 120 is not injected. If the main propellant injector does not inject the internal film coolant 120 then that coolant can be injected by separate manifold/injector that injects only internal film coolant 120 as does the internal film coolant manifold 410 in FIG. 1. The main propellant includes oxidizer 116 and fuel 118. The fluid flowing into and through the thrust chamber includes the oxidizer 116, fuel 118 any additional cooling fluids for cooling the thrust chamber 102. The internal film coolant 120 is often known as “coolant A.” The main propellants can be a mono-propellant, or a plurality of main propellants.

When injected, the internal film coolant 120 spreads into a thin film on the inside wall 104. The function of internal film coolant 120 is two-fold: 1) to absorb heat directly as a coolant, thus reducing heat flow to the inner wall 104 (and thereby reducing wall temperature), and 2) to deposit carbon in the form of “carbon black” or soot on the inner surface of the engine's thrust chamber 102 (i.e. a process called “coking”), the soot being an insulator with very low thermal conductivity and will greatly reduce the amount of heat that flows through the thrust chamber 102 hot wall 104 and into an external convective coolant 126 described below.

The main propellant injector 114 is similar to a showerhead that sprays liquid propellants, such as an oxidizer 116 of liquid oxygen and a fuel 118 of jet fuel, into the combustion chamber 106 where the oxidizer 116 and fuel 118 are burned. After combustion, the burned propellants expand in the expansion nozzle 108 where the burned propellants increase to high velocity and produce thrust. The internal film coolant 120 provides protection from excessive heat by introducing a thin film of coolant injected through orifices (or equivalent) around the injector periphery or through manifolded orifices (as shown in FIGS. 1, 4, 5, and 10) in the thrust chamber inside wall 104 near the main propellant injector 114 or chamber throat region 122 or anywhere else in the thrust chamber 102 where internal film coolant is helpful. The liquid propellants can be a mono-propellant, or a plurality of liquid propellants.

Propulsion system 100 also includes one or more coolant tube(s) 124 that circumscribes at least a portion of the exterior surface 112 of the thrust chamber 102. The one or more coolant tube(s) are operable to circulate an external convective coolant 126. The external convective coolant 126 is often known as “coolant B.” In some implementations of systems 100, the number of coolant tube(s) 124 is a small number of coolant tubes, such as four or five coolant tubes and a few coolant tubes as two coolant tube(s) 124. In some implementations of system 100, system 100 includes only one coolant tube. In some implementations, system 100 includes a few coolant tube(s) 124. In some implementations, the coolant tube(s) 124 circumscribe a portion or all of the exterior surface 112 of the thrust chamber 102 shell 132.

The one or more coolant tube(s) 124 circumscribes the exterior 112 of the thrust chamber 102 starting at the expansion nozzle 108 at any area ratio, but an area ratio of 2 to 4 can be considered as typical. The one or more coolant tube(s) 124 surrounds the upper part of the expansion nozzle and continues up towards the combustion chamber 106 like a coil, until the coolant tube(s) reaches the top of the combustion chamber 106, after which the one or more coolant tube(s) 124 is redirected downward to the expansion nozzle 108, where the coolant tube(s) directs the external convective coolant (water as an example) into the nozzle as an internal film coolant to cool that portion of the expansion nozzle 108 not cooled by the one or more coolant tube(s) 124 (i.e. the nozzle shell 1048). Alternative methods for cooling the nozzle shell 1048 include dump cooling, transpiration cooling, ablative cooling, or other conventional cooling methods used in the rocket industry.

Propulsion system 100 also includes a nozzle film coolant manifold 1057 that is operably coupled to the expansion nozzle 108. The nozzle film coolant manifold 1057 is operable to distribute and inject the external convective coolant 126 onto the interior 110 of the expansion nozzle 108 as a film coolant.

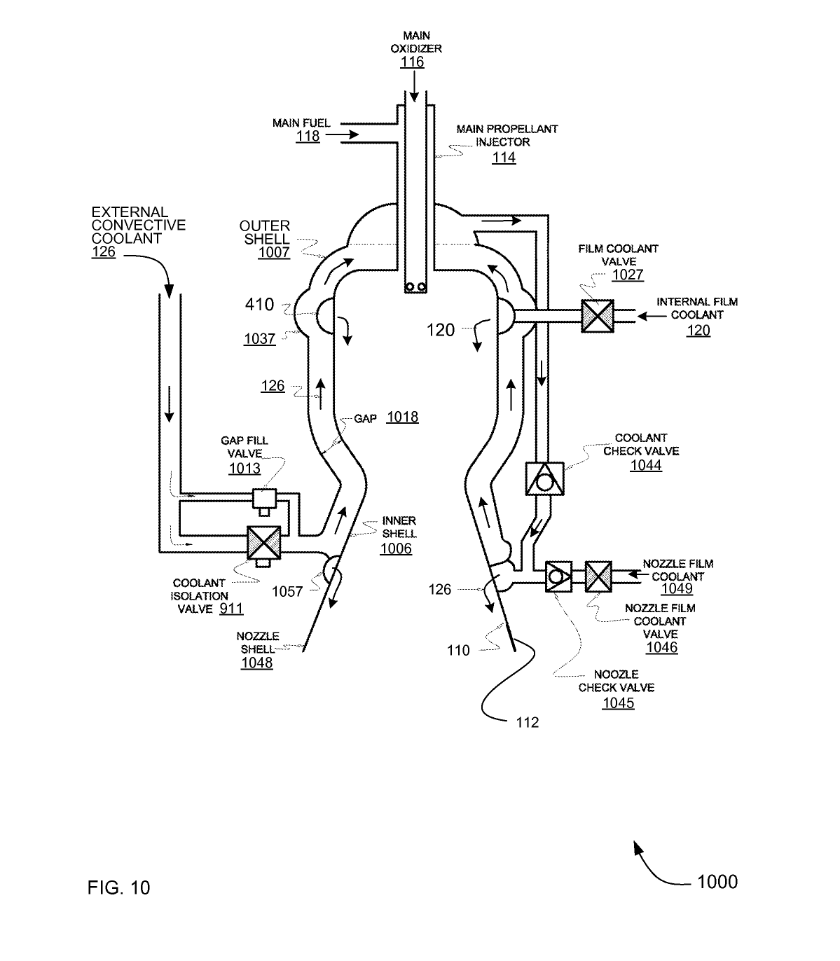

In some implementations, instead of using a single-layer shell 132 with a tube(s) 124 wrapped around the shell 132, two shells (the inner shell 1006 and the outer shell 1007) having a gap 1018 in between the two shells for the external convective coolant 126 to flow within the gap 1018 are implemented as shown in FIG. 10. The two shells can be secured directly or indirectly to each other at their two ends (e.g. top and bottom ends) or the two shells can be secured to each other at many points throughout the surface area using any means necessary including bolts, rivets, welds, brazing, or any other means. In addition, spacers and/or ribs of any configuration can be built into or added to the shells anywhere to maintain proper shell spacing and/or to ensure sufficient shell structural characteristics. This alternative construction method will be discussed further in sections that follow.

To strengthen the thrust chamber structure, the outer surface of the external coolant tube and/or shell(s) can be overwrapped with filament winding or other composite material including, but not limited to graphite/epoxy, Kevlar/epoxy, glass/epoxy, metal wire/epoxy, and others including nonepoxy based composites.

The thrust chamber shell(s) and coolant tube(s) 124 can be fabricated using any conventional methods or materials of shell fabrication so long as the shell(s) and coolant tube(s) 124 have sufficient strength and heat conductivity needed to conduct heat to the external convective coolant 126 without overheating and/or failure. Methods of shell and coolant tube construction include, but are not limited to, spinning, rolling, welding, stamping, punching, extruding, explosive forming, drawing, plasma spraying, electroplating, brazing, riveting, and other methods.

In some implementations, the thrust chamber 102 can be fabricated in a similar way to a conventional regeneratively cooled thrust chamber: with numerous parallel coolant tubes brazed, electroplated, welded, or soldered together (or other methods) with or without a metal jacket or filament overwrapping on the exterior surface. Or, the thrust chamber can be fabricated like another type of regeneratively cooled thrust chamber using cooling channels as opposed to tubes and fabricated using electroplating, plasma spraying, or other methods.

The top portion of the combustion chambers 106 sometimes used with pintle main propellant injectors 114 is known as a dome 130. The dome shown in system 100 is a double-walled thrust chamber dome 130 with external convective coolant 126 flowing between the two walls of the double-walled dome 130 and cooling the dome 130. The external convective coolant 126 flows from the one or more coolant tube(s) 124 to the interior of the dome's double-shell and then into a tube (see FIG. 1) that routes the external convective coolant 126 to the expansion nozzle 108 where the external convective coolant 126 film-cools the expansion nozzle 108 or more specifically the nozzle shell 1048. The dome 130 can either be a simple double-shell where both walls (or shells) of the dome 130 are unattached to each other (except at the ends), or the two walls can be attached to each other with rivets, bolts, welding, brazing, electroplating, or plasma spraying, or any other process. The dome 130 can also have coolant flow channels or spacers fabricated or installed into the dome 130, or no channels or spacers at all.

The proportions of the internal film coolant 120 and external convective coolant 126 provide for a high degree of thrust while maintaining acceptably low temperatures in the thrust chamber 102 (i.e. maximums are approx 350 to 800 degrees Fahrenheit). Cooling of the thrust chamber is accomplished while sustaining acceptably low values of losses to thrust. The combination of a shell 132 and coolant tube(s) 124 avoids the need for a large number of expense expensive individual coolant tubes that are difficult to manufacture. As a result, system 100 uses a minimal number of coolant tubes. System 100 greatly minimizes the number of fluid coolant tube(s) 124 necessary to cool the thrust chamber 102 to at most, several coolant tubes at the most, which greatly simplifies and expedites fabrication of the thrust chamber 102 using conventional and simple fabrication techniques, such as fabrication techniques that involve but are not limited to spinning and winding, stamping and welding, and explosion forming and welding.

In one example, the thrust chamber 102 can be manufactured using the following process:

1.) Select shell material.

2.) Anneal the shell material.

3.) Spin shell material into appropriate shapes including the dome, cylindrical section of the combustion chamber, the conical section, and the expansion nozzle.

4.) Anneal the spun shell components again.

5.) Machine the internal and nozzle film coolant manifolds.

6.) Weld thrust chamber shell components together. Install spacers and/or stiffeners in the double wall dome as required.

7.) Grind off excess weld.

8.) Wind external coolant tube around thrust chamber with brazing compound. Brazing compound can be heat solidified during welding or solidified all at once in a brazing oven. Heat the tubing as required for appropriate softness during winding.

9.) Braze external coolant tube to appropriate injection manifolds.

In addition, the low to moderate temperatures in the thrust chamber 102 allows the use of a simple thin metal shell structure as a thrust chamber 102, as shown in FIG. 1.

System 100 provides a low-cost fluid cooled rocket thrust chamber 102 that is simpler to fabricate than conventional regeneratively cooled thrust chambers. System 100 includes a greatly simplified light-weight, fluid-cooled thrust chamber 102 that can be used in conjunction with a wide range of rocket engine main propellant injector 114 types, a wide range of rocket engine thrust size, or utilizing a wide range of propellant combinations.

In one example, the amount of internal film coolant 120 flowrate that is introduced or injected onto the inside wall 104 of the thrust chamber 102 is typically in a range of about 1% to about 5% of the total fluid flow to the engine (i.e. the “fluid”) but other values can be used. In another example, the amount of internal film coolant that is introduced or injected onto the inside wall 104 of the thrust chamber 102 is about 2.5% of the fluid. In yet another example, the amount of internal film coolant that is introduced or injected onto the inside wall 104 of the thrust chamber 102 is about 3.5% of the fluid. In yet a further example, the amount of external convective coolant 126 flowrate that is introduced or injected onto the interior wall 110 of the expansion nozzle 108 is typically will fall in a range of 1% to 5% of the fluid flowrate but other values can be used. In still yet another example, the amount of internal film coolant that is introduced or injected onto the inside wall 104 of the thrust chamber 102 is about 3.5% of the fluid and the amount of external convective coolant 126 that is introduced or injected onto the interior 110 of the expansion nozzle 108 is about 2.75% of the fluid. Typical expected values for both the internal film coolant 120 and the external convective coolant 126 can be but not limited to 3.5% and 2.75% of total fluid flow respectively.

While the system 100 is not limited to any particular thrust chamber 102, inside wall 104, combustion chamber 106, expansion nozzle 108, expansion nozzle interior 110, expansion nozzle exterior 112, main propellant injector 114, oxidizer 116, fuel 118, internal film coolant 120, one or more coolant tube(s) 124, an external convective coolant 126, internal film coolant manifold 410, and a nozzle film coolant manifold 1057, for sake of clarity a simplified thrust chamber 102, inside wall 104, combustion chamber 106, expansion nozzle 108, expansion nozzle interior 110, expansion nozzle exterior 112, main propellant injector 114, oxidizer 116, fuel 118, internal film coolant 120, one or more coolant tube(s) 124, an external convective coolant 126, internal film coolant manifold 410, and a nozzle film coolant manifold 1057 are described.

### Apparatus Implementations

In the previous section, a system level overview of the operation of an implementation was described. In this section, particular apparatus of such an implementation are described by reference to a series of diagrams.

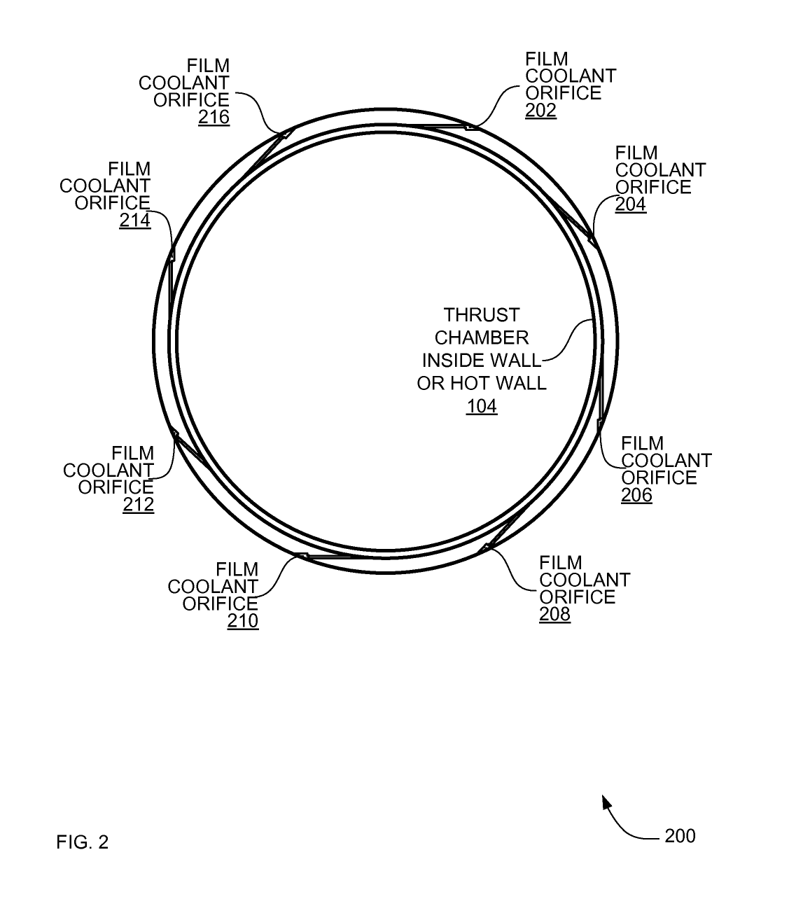

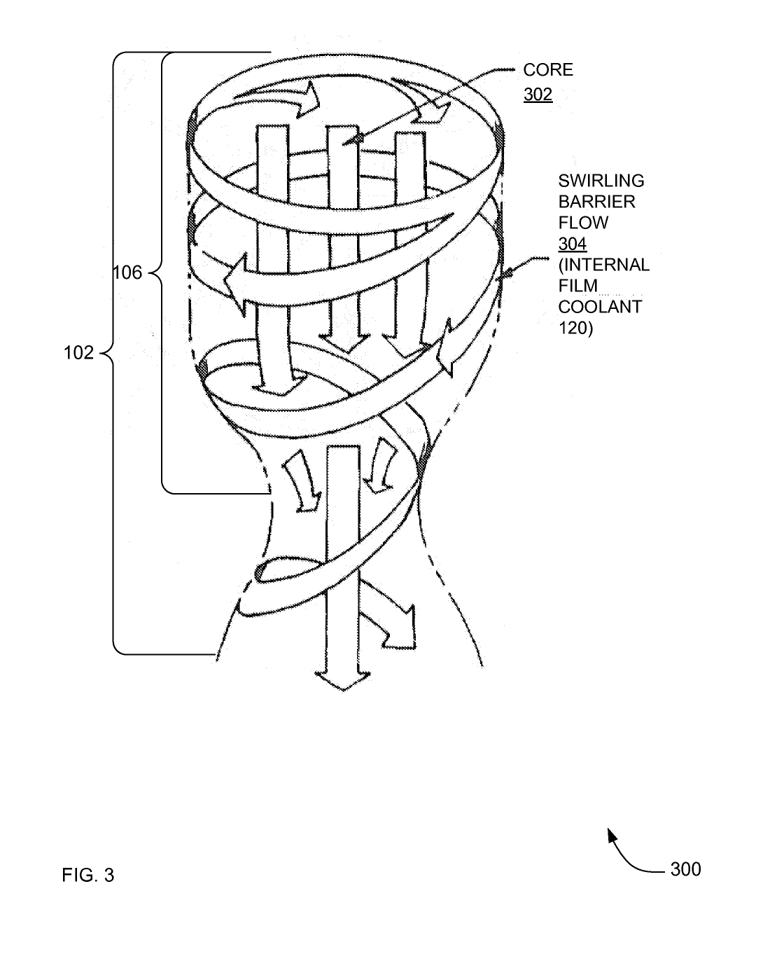

FIG. 2 and FIG. 3 show examples of a vortex injection pattern for internal film coolant 120 film injection onto a hot thrust chamber wall. Other patterns and methods for injecting internal film coolant are also possible.

FIG. 2 is a cross section top-view block diagram of combustion chamber apparatus 200 having film coolant orifices, according to an implementation. Apparatus 200 simplifies and expedites the production of a fluid-cooled rocket engine thrust chamber 102. Apparatus 200 helps solve solves the need in the art for a thrust chamber made of less expensive materials and manufacturing processes.

Apparatus 200 includes one or more film coolant orifices that inject an internal film coolant fluid 120 onto the inside wall of a thrust chamber 102. In some implementations, the fluid is external convective coolant 126 that is injected onto the interior wall 110 of the expansion nozzle 108. Apparatus 200 includes but is not limited to eight film coolant orifices 202, 204, 202, 206, 208, 210, 212, 214 and 216. However the orifices can be any shape, number, size, or orientation, and can be located any where in the thrust chamber where coolant is needed. The internal film coolant fluid can be any coking fluid or non-coking fluid or any fluid that adequately reduces heat flow into the thrust chamber hot wall 104. In addition, the processes and alternatives of film coolant and film coolant injection in the combustion chamber 106 also apply to the injection of film coolant in the expansion nozzle 108 or anywhere else in the thrust chamber 102.

The injection of the fluid through the orifices and onto the inside wall 104 of the thrust chamber 102 maintains the inside wall of the shell 132 at modest temperatures, such as temperatures below 1300 degrees Fahrenheit. Temperatures below 1300 degrees Fahrenheit do not require excessively exotic, rare, or expensive materials. Instead, low-to-moderate cost and readily available materials that maintain their strength at low-to-medium temperatures (below 1300 degrees Fahrenheit) can be used for the thrust chamber. For example, the thrust chamber can be made of but not limited to aluminum, steel, alloy steel, stainless steel, Inconel®, copper, bronze, alloys thereof, mixtures thereof, and metal composites and plastic composites. Inconel® is a registered trademark of Special Metals Corporation of New Hartford, N.Y., referring to a family of austenitic nickel-based superalloys. Inconel® alloys are oxidation and corrosion resistant materials well suited for service in extreme environments. When heated, Inconel® forms a thick, stable, passivating oxide layer protecting the surface from further attack. Inconel® retains strength over a wide temperature range, which is helpful in implementations where aluminum and steel can soften. The heat resistance of Inconel® is developed by solid solution strengthening or precipitation strengthening, depending on the alloy.

Designing and operating the thrust chamber shell 132 for relatively low temperatures allows for a thrust chamber having a shell wall thickness typically (but not always) of typically between about 0.030 inches and about 0.10 inches, but the shell 132 thickness range could also be 0.010 inches to 0.50 inches. Other thicknesses can be used as well. In some implementations, the thrust chamber wall thickness is between about 0.030 inches and about 0.040 inches. In some implementations, the thrust chamber wall thickness is about 0.030 inches. These thicknesses do not include the thickness of any stiffeners, tubes, ribs or other structure added to the shell 132.

The thrust chambers of FIGS. 1, 4, 5, and 10 are less elaborate than conventional fluid cooled chambers, and operates at low-to-medium inner surface temperatures on the inside wall of the shell 132, below about 1300 degrees Fahrenheit, approximately the exhaust temperature of high-performance internal combustion automotive engines. Such a moderate operating temperature range allows the use of conventional materials and processes in the fabrication of the thrust chamber 102. Thus, the thrust chamber 102 can be produced by many more low-cost, low-overhead, commercial vendors than are currently producing conventional thrust chambers.

FIG. 3 is an isometric block diagram of a thrust chamber that shows a swirling flow of a layer of internal film coolant along the thrust chamber inside wall, according to an implementation.

In FIG. 3, internal film cooling fluid is injected tangentially into the combustion chamber of the thrust chamber. Core flow 302 from main propellants is inside the swirling surface flow and parallel to the engine long axis. This method of internal film coolant injection in an example only since any injection method can be used so long as the coolant is distributed over those areas requiring film coolant. The main propellants can be a mono-propellant, or a plurality of main propellants.

Tangential injection of fluid shown in FIG. 2 above creates a swirling flow 304 of the internal film coolant 120 layer against or along the thrust chamber inside wall (or hot wall) 104. The swirling flow 304 can also be described as a vortex flow resulting from the injection method shown in FIG. 2.

The thrust chamber inside shell wall 104 is also known as a “hot wall” because the heat of the combustion is generated inside of the thrust chamber 102. More specifically, the great bulk of the heat of combustion is generated inside of the combustion chamber 106.

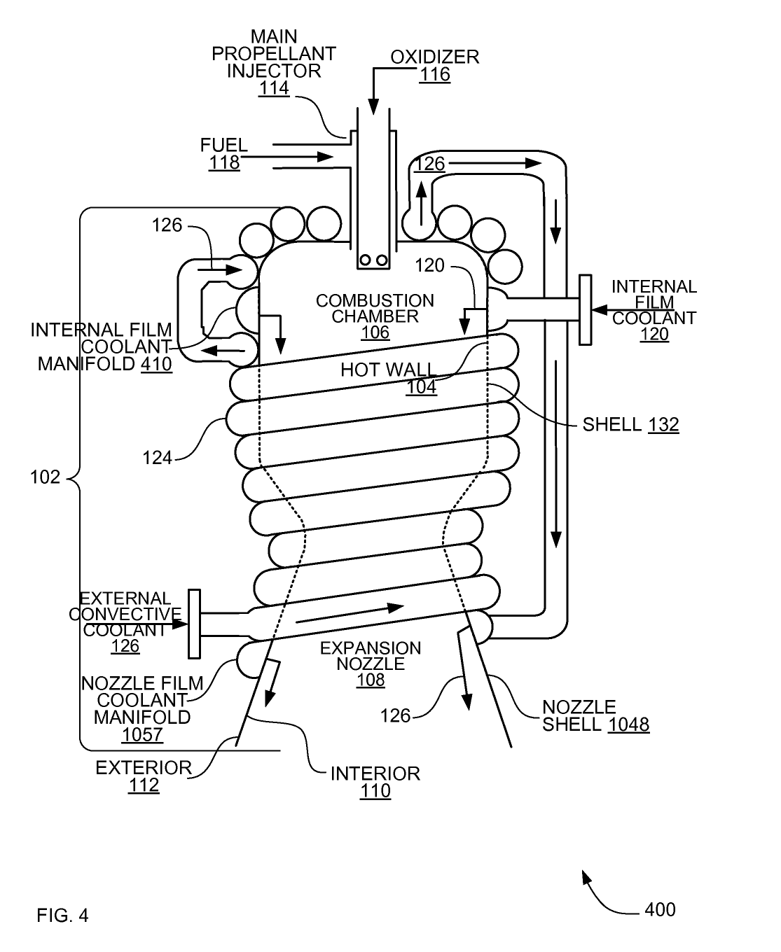

FIG. 4 is a cross section side-view block diagram of a propulsion apparatus 400, according to an implementation having a single-walled dome 130 and spiraling cooling tube(s) on the dome 130. The apparatus of FIG. 4 is substantially similar to that shown in FIG. 1, except that in FIG. 4, the dome 130 has a single wall and the spiraling cooling tube(s) continue upwards to cover the dome 130. In FIG. 4, both the thrust chamber 102 and dome 130 are cooled by external coolant tube(s).

In FIGS. 1, 4, 5, and 10 cooling of the expansion nozzle 108 is accomplished as follows: After cooling the bulk of the thrust chamber 102 by flowing external convective coolant 126 in the one or more coiled coolant tube(s) 124, the external convective coolant 126 is then injected as a film coolant along the interior wall 110 (i.e. hot wall) of the expansion nozzle 108, more specifically the nozzle shell 1048. Because the expansion nozzle 108 is of low static pressure as compared to the combustion chamber 106, on the order of 10-30 times less, the pressure and boiling point range of the external convective cooling system within which the thrust chamber 102 can be manufactured and operated is very broad. Therefore, the pressure of the external convective coolant 126, and in turn, heat absorbing capacity of the external convective coolant 126, can be selected to optimize the amount of external convective coolant 126 for a given type of engine. The broad range of the pressure of the external convective coolant 126 at which the thrust chamber 102 can be manufactured for and operated at provides a variety of operating scenarios such as increasing the external convective coolant 126 system pressure in order to increase the heat absorbing capacity and thus decrease the amount of external convective coolant 126 that is required, or of decreasing the external convective coolant 126 system pressure to decrease the tankage and pressurant gas weight supplying the external convective coolant 126 in a “pressure-fed” rocket system, or to decrease the pumping horsepower requirements (if a system that uses a pump to pressurize the external convective coolant 126 is used). Cooling the nozzle as described in FIGS. 1, 4, 5, and 10 simplifies the design of a nozzle extension (i.e. the nozzle shell 1048). The nozzle shell 1048 is that portion of the expansion nozzle 108 that is downstream of the injection point of the external convective coolant 126 in the expansion nozzle 108 as film coolant. In the example of FIGS. 1, 4, 5, and 10, the nozzle shell 1048 is fabricated of a simple thin sheet metal, metal composite, or plastic composite material.

The pintle injector implementation of the main propellant injector 114 that is shown in FIGS. 1, 4, and 10 was originally developed in the early 1960's. The dome 130 of a propulsion system using a pintle injector is the top of the thrust chamber 102. The dome 130 in FIG. 4 is a single metal shell that has the one or more coolant tube(s) 124 continuing to wind around the dome 130 in a spiral path and bonded (using soldering, brazing, or other methods) to an outer surface of the dome 130. The double-walled dome 130 shown in FIG. 1 is unnecessary when a single-walled dome shell with the one or more coolant tube(s) 124 is bonded (soldered, brazed, or other methods) to an external surface of the single-walled dome. The dome 130 of FIGS. 1, 4 and 10 can be dome-shaped, conical, flat, or other shapes.

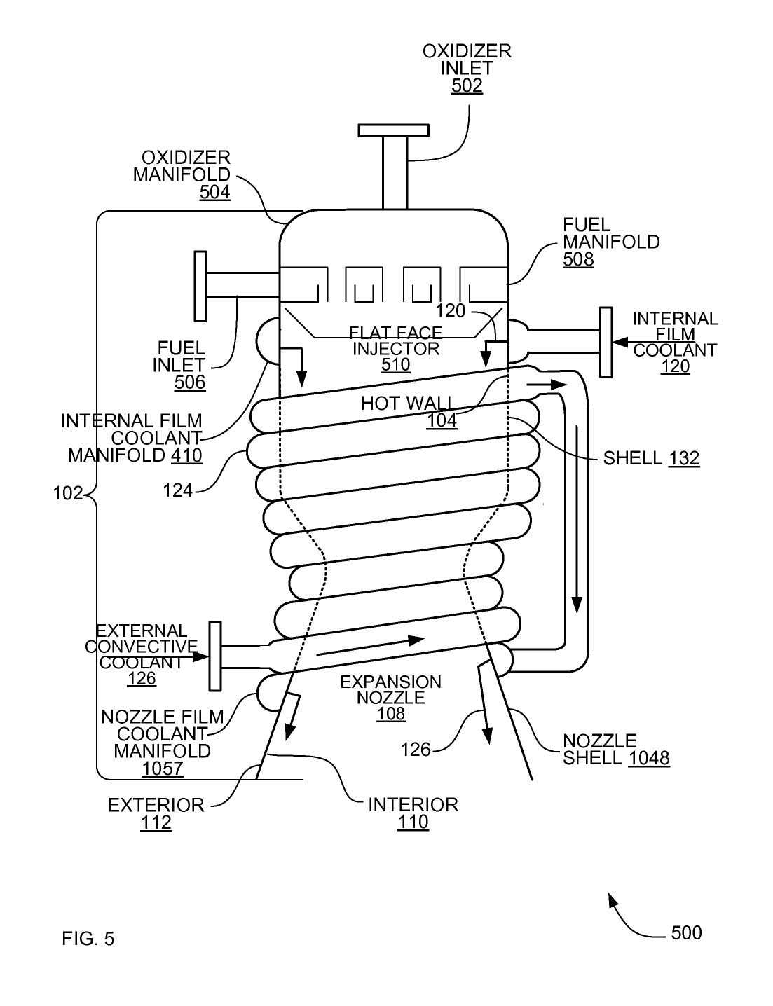

FIG. 5 is a cross section side-view block diagram of propulsion apparatus 500 including a flat-faced propellant injector and a fluid-cooled thrust chamber, according to an implementation. Apparatus 500 includes an oxidizer inlet 502 for routing an oxidizer to the combustion chamber 102. Apparatus 500 also includes an oxidizer manifold 504. Apparatus 500 also includes a fuel inlet 506, a fuel manifold 508 and a flat-face main propellant injector 510. The flat-face main propellant manifold 510 injects the main propellants into the combustion chamber and sometimes injects internal film coolant when the internal film coolant is not injected into the combustion chamber through an internal film coolant manifold 410 that is separate from the flat-face propellant injector 510. In some implementations, the manifold for the internal film coolant can be built into the circumference of the flat-face main propellant injector (as orifices or equivalent formed in the perimeter of the face of the flat-face injector) or the internal film coolant manifold 410 can be a separate manifold as shown in FIG. 5. Other implementations use other means of injecting internal film coolant 120. The main propellants can be a mono-propellant, or a plurality of main propellants.

In apparatus 500, internal film coolant 120 is routed into an internal film coolant manifold 410 that is separate from the flat-face main propellant injector 510. In this example the internal film-coolant manifold 410 is an external tube manifold that forms a film-coolant injection ring around the base of dome 130 of the combustion chamber 106. Internal film coolant 120 is injected through holes in the internal film coolant manifold 410 into the combustion chamber 102.

External convective coolant 126 is fed into the coolant tube(s) 124. The external convective coolant 126 passes in-between double walls (not shown) of the thrust chamber 102 dome 130 and then is injected in the expansion nozzle 108 where external convective coolant 126 cools the expansion nozzle 108 as a film coolant. In some implementations, a pintle injector is used as a main propellant injector 114. In other implementations, other flat-face propellant injectors 510 are used as the main propellant injector 114. Other main propellant injector 114 configurations are also possible.

Apparatus 500 can be implemented with many flat-face main propellant injector configurations such as those similar to the injectors in the Space Shuttle SSME and the Apollo J-2, H-1, and F-1 engines. The Space Shuttle SSME and the Apollo J-2, H-1, and F-1 engines do not have a thrust chamber dome 130 at the top of the combustion chamber 106 similar to the pintle injector engine, rather these engines have a flat-face main propellant injector 510 with a number of holes in it, analogous to a conventional bathroom shower-head. With this type of main propellant injector 114 the thrust chamber 102 cooling system configuration is similar to that of the previously described cooling system for the pintle injector engine with the exception that there is no thrust chamber dome 130 to cool with the external convective coolant 126. However, such flat-face injector rocket engines can include a propellant dome such as an oxidizer dome or fuel dome at the top of the thrust chambers. The propellant dome is actually a propellant manifold that directs propellant (usually the oxidizer) to a main propellant injector 114 and are usually not located in the thrust chamber 102 in a position that exposes the propellant directly to hot combustion gases prior to injection into the combustion chamber 106. Such structures are not confused with a thrust chamber dome 130 of a pintle injector engine. In FIG. 5 the propellant dome is shown as the oxidizer manifold 504 although the propellant dome can be a fuel manifold according to the specifications of the designer. The propellant can be a mono-propellant, or a plurality of propellants.

The systems, methods and apparatus described herein are not limited by particular implementations. For example, variations of the thrust chamber 102, which can include any shape, size, or geometry of thrust chamber 102 including thrust chambers with the conventional cylindrical combustion chambers 106 or spherical combustion chambers, such as in the German WW2 V2 rocket engine, or other combustion chamber shapes.

In some implementations, the external convective coolant 126 can flow in the one or more coolant tube(s) 124 or in a gap 1018 between shells (see FIG. 10) in either the “up” or “down” directions. More specifically, as shown in FIGS. 1, 4, 5, and 10 the one or more coolant tube(s) 124 or gap 1018 flow passage can begin at the expansion nozzle 108 and flow upwards towards the main propellant injector 114 (i.e. counter-current flow), or the one or more coolant tube(s) 124 or gap 1018 flow passage can begin flowing near the injector-end of the engine and flow downward towards the expansion nozzle 108 where the external convective coolant 126 is injected into the expansion nozzle 108. Or the one or more coolant tube(s) 124 or gap 1018 flow passage can begin and end anywhere in the thrust chamber 102 where helpful.

In some implementations, the external convective coolant 126 is circulated in the external coolant tube(s) 124 in a liquid state (all liquid), as a boiling liquid (two phase fluid), in a gaseous state (as a gas or vapor), as a supercritical fluid, or in any physical state or phase that will absorb the heat that is transferred through the shell 132.

Although FIGS. 1, 4 and 5 show a single coolant tube(s) 124 wound around the thrust chamber 102. In some implementations, two, several, or more coolant tube(s) 124 can be wound around the thrust chamber 102 in parallel to each other; or, alternatively, a small number of stacked tubes (toruses) can be connected together by two or more vertical manifolds providing inlet(s) and outlet(s) for each ring. In some implementations, each of the coolant tube(s) 124 flow external convective coolant 126, and the coolant tube(s) 124 are bonded in place using soldering, welding, brazing, or other methods. The exact number and configuration of one or more coolant tube(s) 124 are various.

In some implementations, the one or more coolant tube(s) 124 can be of any material, wall thickness, or shape in cross-section as long as the coolant tubes transfer the heat that flows through the thrust chamber 102 shell 132 to the external convective coolant 126. Other implementations of the coolant tube(s) 124 include tubes made of but not limited to copper, stainless steel, Inconel®, steel, bronze, aluminum, and nickel or alloys, mixtures, or composites of any of these materials or other materials that have the appropriate fluid compatibility, strength, and heat transfer properties. In some implementations, the cross-section shape of the coolant tube(s) 124 can be circular, square, octagonal, hexagonal, round on one side and flat on the other, oval, or any other shape that will carry fluid and transfer an adequate amount of heat.

In some implementations, the one or more coolant tube(s) 124 are modified to be a half-tube, as opposed to the full perimeter tube described in FIGS. 1, 4 and 5, that is bonded (i.e. soldered, brazed, welded, or other attachment method) to the thrust chamber 102 exterior wall. The half-tube is a coolant tube(s) 124 that is shaped like a full tube that has been split in half along its length and is wound around the thrust chamber 102 as shown if FIGS. 1, 4, and 5. Similar to a full tube, the half-tube can be of any cross-sectional shape or material so as long as coolant tube(s) 124 transfers allows the heat flowing through the thrust chamber 102 to be transferred to the external convective coolant 126. The half-tube coolant tube(s) 124 is bonded to the thrust chamber 102 with its open side facing the thrust chamber 102, thus forming a flow passage for external convective coolant 126. Any cross-sectional shape of coolant tube can be used including but not limited to a circle, square, rectangular, round on one side and flat on the other, octagonal, hexagonal, and others, or any combination of these and others.

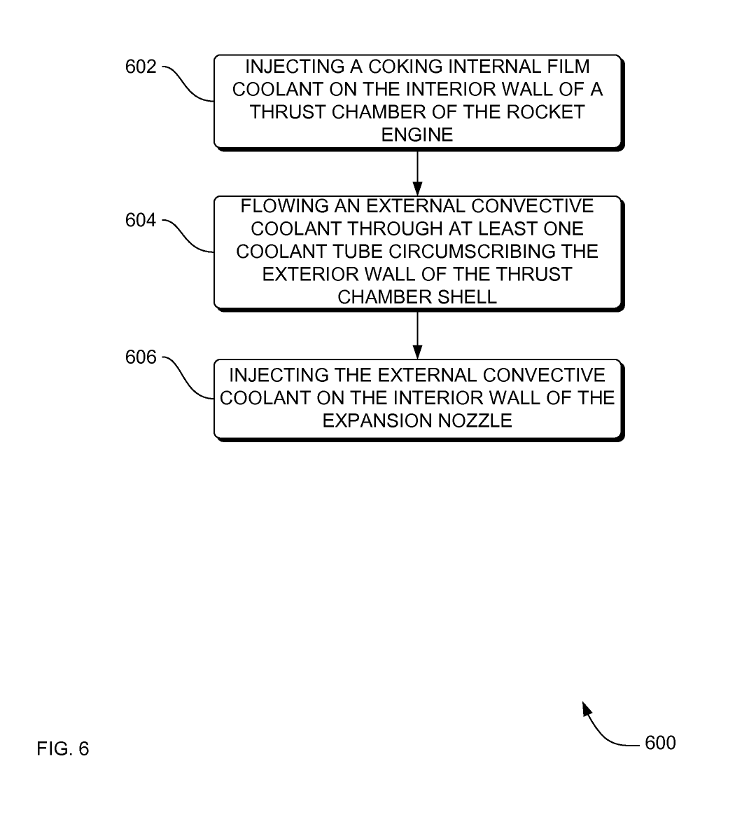

In some implementations, either or both of the internal film coolant 120 and the external convective coolant 126 can be different types of fluid than those that make up the main propellants. In one aspect as shown in FIG. 1, dual coolants can be used for the internal film coolant 120 and the external convective coolant. For example, in a rocket engine using liquid oxygen and liquid hydrogen as its main propellants, the internal film coolant 120 can be one of many different coking fluids, and the external convective coolant 126 can be hydrogen, water or other non-coking fluid that will absorb the required heat. That is, the external convective coolant 126 is not significantly coking or residue depositing at the maximum temperature any portion of the external convective coolant 126 achieves when in the coolant tube(s) 124. In some implementations, the minimization of the number of one or more coolant tube(s) 124 is achieved in part because of the dual use of two kinds of cooling fluids: a “coking” internal film coolant 120 and a “non-coking” external convective coolant 126. The dual coolants are described in greater detail in conjunction with FIG. 6 below. The main propellants can be a mono-propellant, or a plurality of main propellants.

As an alternative to cooling the thrust chamber dome with wrapped coiled external coolant tubes or a double wall dome, the dome 130 or nozzle shell 1048 can be cooled with a conventional ablative material mounted to the inside surface of the dome. In some implementations, the thrust chamber dome 130 or nozzle shell 1048 is transpirationally cooled (as in conventional transpiration cooling), or the thrust chamber dome can be uncooled if the main propellant injector 114 causes the steady-state temperature of the dome 130 to be low enough to operate without a cooling system. Where helpful any portion of the thrust chamber 102 can be cooled with other conventional cooling methods not described herein which includes but is not limited to regenerative, ablative, transpiration, dump, film cooling and others.

The external coolant tube(s) can be any shape, material, or wall thickness so long as the tube(s) can adequately absorb the heat being conducted through the wall of the thrust chamber.

In some implementations, the external convective coolant and internal film coolants are, as per the preferences of the designer, modified with any type of conventional additives. Variations can include, but are not exclusive to, changing the boiling or freezing points of the fluids or the viscosity of the fluids or other properties.

This type of rocket thrust chamber 102 cooling system can be used to cool any type of rocket engine thrust chamber 102, whether the engine receives main propellants delivered as a pressure-fed rocket engine (i.e. main propellants fed to the engine solely by pressurizing the main propellant tanks) or whether the rocket engine is pump-fed (i.e. where the main propellants are fed to the engine by a pump or pumps, usually but not always a turbopump/turbopumps). If implemented as shown in FIGS. 1, 4, 5, and 10 the thrust chamber 102 cooling system can operate completely independently of the turbopump system making development of both systems easier and less costly.

The thrust chamber 102 cooling system can be used on hybrid propellant rocket thrust chambers 102 and/or expansion nozzles 108 as well as liquid propellant rocket engine thrust chambers 102 and/or expansion nozzles 108. Liquid propellant rocket engines can use any number of liquid propellants. Hybrid rockets have at least one (possibly more) propellant that is a liquid and at least one propellant that is a solid, such as a rubber or plastic. The internal film coolant 120 or external convective coolant 126 can either be the hybrid rocket's liquid main propellant or can be part of the propulsion system as a separate tank, cooling fluid, and plumbing system. The thrust chamber 102 cooling system can also be used with solid propellant rockets thrust chambers and expansion nozzles if the tanks and plumbing and coolants are carried on board (onboard the rocket vehicle or propulsion system) for the internal film coolant 120 and the external convective coolant 126. The thrust chamber 102 cooling system can also be used to cool any other heated components of rocket systems requiring cooling such as portions of a solid propellant rocket motor case.

A nonlimiting variation is to prechill the internal film coolant 120 or the external convective coolant 126 before they are loaded into the propulsion system to increase their effectiveness as coolants. For instance, if the external convective coolant 126 happens to be water, then the water can be chilled to (for example) 36 degrees Fahrenheit or just a few degrees above freezing. This prechilling will allow a coolant to absorb more heat before boiling. Another method of chilling these coolants is to flow one or both of them through a heat exchanger that is cooled by all or a portion of the rocket engine's main propellants or the rocket vehicles pressurizing fluid (such as helium for example).

As a nonlimiting variation the coolant tube(s) 124 can overlap either the internal film coolant manifold 410 or the nozzle film coolant manifold 1057 as necessary to avoid gaps in cooling the thrust chamber 102.

The thrust chambers 102 can be fabricated with any material, coating, or manufacturing process where helpful.

Note that the arrows inside the lines (i.e. the tubes, pipes, channels, or flow passages that carry fluid) shown in the figures indicate the direction of flow of the fluid in that line.

Any valves in the system are optional and can be added in various implementations to improve coolant handling, loading, and draining, system operation and timing, safety, minimizing coolant quantity, and/or to prevent collapse of the inner shell 1006 (of the dual-shell implementation described below) in those implementations where the external convective coolant 126 in the gap 1018 (see below) is at a higher pressure than the minimum collapse pressure of the inner shell 1006. The valves include but are not limited to manual valves, actuated valves, relief valves, check valves, and others, and the valves can be located anywhere on the thrust chamber 102 or in the cooling system.

A nonlimiting variation is to use an external convective coolant 126 that flows through the gap 1018 or the coolant tube(s) 124 and then is injected as an internal film coolant 120. Or, the thrust chamber 102 can use an external convective coolant 126 that flows through the gap 1018 or coolant tube(s) 124 and then is injected into the expansion nozzle 108 as a nozzle film coolant but does not use an internal film coolant 120.

For the dual-shell thrust chamber 102 nonlimiting variation that is shown below, in one implementation bolts or bolts and gap spacers secure the inner and outer shells 1006, 1007 to each other at the appropriate gap 1018 spacing. The bolts and spacers can have holes through them for coolant to flow through to cool the bolts and spacers as needed. In implementations where the bolt(s) penetrate a hole in the inner shell 1006 combustion gases from the interior of the thrust chamber may flow through the hole (if gap pressure less than the local thrust chamber interior pressure) around the bolt(s) and into the gap 1018 thus adversely affecting the heat transfer characteristics of the thrust chamber cooling system. Where such is the case the bolts can be appropriately sealed between the bolt and inner shell 1006 using any helpful means (for example, braze, solder, or other means). However, in cases where no additional sealing is used around the bolt(s) the gap 1018 pressure can be controlled such that the gap pressure is always slightly higher (for example a few psi) than the interior pressure of the thrust chamber 102 to prevent combustion gas from leaking into the gap 1018.

### Method Implementations

In the previous section, apparatus of the operation of an implementation was described. In this section, an implementation of a particular method is described by reference to a flowchart.

FIG. 6 is a flowchart of a method 600 to cool a rocket engine according to an implementation. Method 600 includes injecting an internal film coolant on the interior wall or hot wall 104 of a thrust chamber of the rocket engine, at block 602.

Some implementations of method 600 also include circulating an external convective coolant 126 through one or more coolant tube(s) 124 circumscribing at least a portion of a thrust chamber 102 of the rocket engine, at block 604.

Method 600 also includes injecting the external convective coolant 126 on the interior wall 110 of the expansion nozzle 108, at block 606. The internal film coolant 120 and the external convective coolant 126 are injected in various proportions described in FIG. 1.

In one implementation briefly described in FIG. 1, FIG. 4, and FIG. 5 above, dual coolants are used for the internal film coolant 120 and the external convective coolant 126. “Coking” hydrocarbon internal film coolant 120 flows the inner wall surface 104 (the hot wall) of the thrust chamber 102 and an external convective coolant 126 flows on the exterior 112 of the thrust chamber 102 inside the one or more coolant tube(s) 124. In some implementations, the internal film coolant 120 minimizes the amount of external convective coolant 126 required.

After coiling around the thrust chamber 102, the one or more coolant tube(s) 124 injects the external convective coolant 126, along the inside surface of the expansion nozzle 108 where the external convective coolant 126 cools the nozzle shell 1048 as a film coolant. The external convective coolant 126 could also cool the nozzle shell 1048 as a dump or transpiration coolant.

The dual coolants include a coking, hydrocarbon internal film coolant 120, (usually a fuel as listed below) that absorbs heat, and that in turn, decreases the amount of heat that is absorbed by the thrust chamber 102 by carbon deposition and heat absorption. The heat that is absorbed by the thrust chamber 102 is then absorbed by the external convective coolant 126, that flows in one or more coolant tube(s) 124 attached to the exterior surface of the thrust chamber 102.

In some implementations, a coking or hydrocarbon internal film coolant 120 is a fuel such as jet fuel (like Jet-A or JP-4), kerosene and kerosene-based fuels, rocket fuel (such as RP-1), propane, butane, and/or liquid or gaseous methane or others. In that variation block 602 of method 600 includes spraying a certain amount of coking internal film coolant 120 against the inside 104 (hot) wall surface of the rocket engine thrust chamber 102 downstream of the main propellant injector 114. The amount of coking internal film coolant 120 is approximately 1 to 5 percent of the total fluid flow to the propulsion system, including the main propellants that can flow through the main propellant injector 114. The amount of internal film coolant 120 can vary beyond the range of 1 to 5 percent. The deposition of carbon is a result of the decomposition of coking internal film coolant 120 by the heat that the coking internal film coolant 120 absorbs from the propellant burning within the thrust chamber 102. The internal film coolant 120 can be injected into the thrust chamber 102 in either the liquid, boiling, supercritical fluid, or gaseous states or other physical states as long as the coking internal film coolant 120 deposits carbon on the inside 104 hot-side surface of the thrust chamber 102.

The reduction of heat flow that results from the deposition of carbon from the internal film coolant 120 means that less heat will flow through the thrust chamber 102 and less external convective coolant 126 will be required on the outside of the thrust chamber 102 to absorb it. Thus a coking hydrocarbon (carbon depositing) internal film coolant 120 film coolant results in less required external convective coolant 126, that in turn results in a more efficient engine that produces higher thrust for a given total fluid flowrate to the rocket engine (i.e. propellant flowrate plus coolant flowrate). The combination of external convective coolant 126 and a coking internal film coolant 120 also provides a simple, low-cost construction with conventional materials as described above. The coking internal film coolant 120 can be injected into the thrust chamber 102 using orifices arranged in a vortex pattern (see FIGS. 2 and 3), injected parallel to the inner wall of the thrust chamber 102, injected perpendicular to the thrust chamber hot wall 104, or injected at an angle to the hot wall 104. To inject the coking internal film coolant 120, any number, shape, size, or orientation of orifices can be used and is up to the discretion of the engine designer. The coking internal film coolant 120 can also be injected in the thrust chamber 102 at as many film coolant injection stations, locations, or rings as the designer wishes. The exact orientation, shape, or number of internal film coolant 120 injection orifices is not critical so long as the areas of the thrust chamber 102 requiring cooling get the appropriate amount of coolant. The options or characteristics apply to the injection of internal film coolant 120 that is injected into the combustion chamber 106 also applies to any film coolant injected into the expansion nozzle 108.

The heat that gets through the carbon layer deposited by internal film coolant 120 and thus through the thrust chamber 102 is absorbed by external convective coolant 126 that is flowing through one or more coolant tube(s) 124 bonded (using soldering, brazing, welding, or other methods) to the outside wall of the thrust chamber 102. In some implementations, the external convective coolant 126 is one of any noncoking fluids (i.e. non-coking at the temperature range when flowing in the external coolant tube) such as water, jet fuel, gaseous hydrogen, liquid hydrogen, propane, methane, or others. One aspiration for the external convective coolant 126 no deposit of significant carbon or other residue within the one or more coolant tube(s) 124 when external convective coolant 126 is at the maximum temperature achieved when the external convective coolant 126 is inside the one or more coolant tube(s) 124. Deposition of carbon or other residue within the one or more coolant tube(s) 124 detrimentally reduces the flowrate of external convective coolant 126 and reduces efficiency of the external convective coolant 126 in absorbing the heat that gets through the thrust chamber 102, thus resulting in high thrust chamber 102 temperatures, high external convective coolant 126 pressure drops, with attendant reduced flow rates, or both.

The function of internal film coolant 120 is to minimize the amount heat flowing through the thrust chamber 102 so the amount of external convective coolant 126 that is required is also reduced. If the amount of external convective coolant 126 is minimized then the number of coolant tube(s) 124 wrapped around the exterior of the thrust chamber 102 can be reduced to one-to-several. This small number of coolant tube(s) 124, combined with the fact that the coolant tube(s) 124 are wound (coiled), or stacked in small numbers, makes the thrust chamber (102) much simpler and cheaper to build.

In some implementations, the external convective coolant 126 is water that circulates in the coolant tube(s) 126. The water external convective coolant 126 flows through the one or more coolant tube(s) 124 upward from the expansion nozzle 108 to the top of the combustion chamber 106. When water external convective coolant 126 flows to the top of the combustion chamber 106 a number of variations of flow can be implementated depending on the exact configuration of the engine. In some examples, the external convective coolant 126 (water in the baseline design) is injected along the internal wall 110 (the hot wall 104) as film coolant in a similar manner that the internal film coolant 120 is injected as film coolant higher up near the main propellant injector 114.

Control of all cooling fluids will be implemented by sequencing valves to release and maintain the flow of cooling fluids to prevent overheating of engine components. Control of the sequencing valves for the cooling fluids are coordinated with timing and operation of the engine main propellant valves and igniter signals. Any method of sequencing of such valves common to or typical of control of rocket engines, such as the use of signals from the rocket vehicle flight computer, or from an independent engine control computer, or other sequencing electronics, can be used to control signals to the coolant control valve(s), and is left to the discretion of the designer.

In some implementations, sufficient pressure is maintained in all coolant fluids so that flow of the coolant fluids is adequate to cool the engine for the operation of the engine during the flight. This pressure can be generated by a number of means, such as through pumps or pressurized gas systems and is at the discretion of the designer.

The flow of engine coolant fluids can be controlled so that coolant is present when the engine generates heat that, in the absence of cooling fluid, would damage the engine. The flow of engine fluid coolants can be controlled by opening and closing valves that gate coolant flow to the engine. The cooling valves are turned ON and OFF at specific times so that A) coolant fluid is not wasted when not needed and 2) coolant flow prevents engine overheating.

Thus, the timed control of coolant valves are coordinated with the main engine valves that turn ON and OFF the flow of main propellant into the rocket engine, because the heat generated by the burning of the main propellants are removed by the coolant to prevent engine overheating and damage. A conventional method of controlling the sequencing of these valves is to use a small engine control computer that is attached to the rocket. This engine control computer can be the flight computer, which also has overall control of the guidance, navigation and control of the rocket vehicle; or the engine control computer can be a dedicated engine control computer acting as a sequencing device.

One purpose of the engine control computer is to generate electrical control command signals that can have at least two electrical control states: a high voltage (or current) state and a low state. Some signal-generating electrical systems can also generate intermediate states so that a continuous signal level, from low to high can be generated. These signals are sent from the computer to the valve actuators. A valve actuator is a mechanical device that generates force and motion in two different directions, depending on level of the electrical states the valve actuator receives from the computer. Thus the control states generated by the computer will have the effect of opening and closing the coolant valves.

In some implementations, the timing of the control signals to the coolant valves is controlled by a software program stored in the engine control computer. The engine control computer has the typical features of any computer, and others common to hardened industrial computers and flight computers on rocket vehicles, namely:

1) A computer application program (software) that is stored in a memory device in the engine control computer.

2) A method of generating the application program and transferring the application program into the engine control computer. In some implementations, the transfer is performed well in advance of operation of the engine.

3) Sufficient built-in hardware common to all computers, such as volatile memory, registers, program counters, etc, needed to support the operation of a stored program capable of executing the application program.

4) A stored program or set of instructions that can execute the application program.

5) Input and output (I/O) lines which are hardwired to the engine control computer that send low-current/low-voltage electrical signals to and from signal conditioners or amplifiers.

6) Signal conditioners or power amplifiers that adjust the amplitude of signals going to and from the engine control computer to controlled devices and external sensors so that these signals can be received by the engine control computer or external device.

7) Environmental hardening so that the engine control computer can withstand conditions typical of rocket flight, including vibration, elevated temperatures, and vacuum conditions.

8) A communications line leading from outside the rocket vehicle to the engine control computer so that external countdown procedures on the ground can trigger the initiation of the applications program. This can be as simple as a single I/O line or can be a serial or parallel line that communicates to ground control.

The application program generates state outputs to the cooling system valves so that cooling fluid flows and prevents excessive temperatures from occurring in the engine.

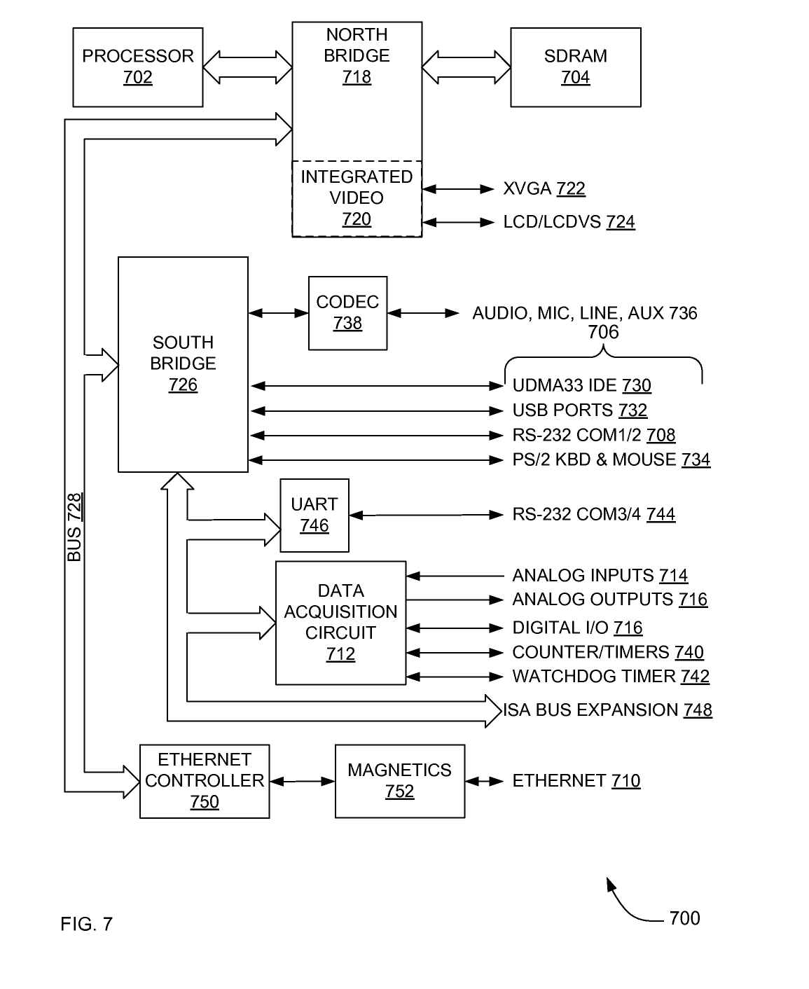

In some implementations, method 600 is implemented as a sequence of instructions which, when executed by a processor, such as processor 704 in FIG. 7, cause the processor to perform the respective method. In other implementations, method 600 is implemented as a computer-accessible medium having executable instructions capable of directing a processor, such as processor 704 in FIG. 7, to perform the respective method. In varying implementations, the medium is a magnetic medium, an electronic medium, or an optical medium.

### Hardware and Operating Environment

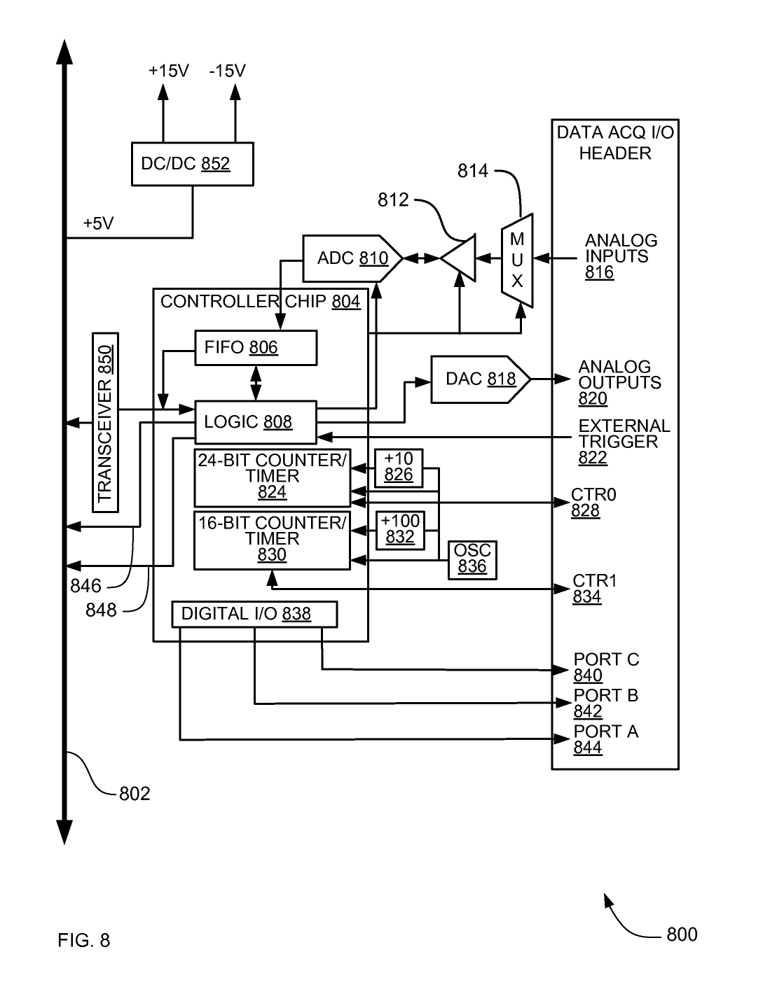

The description of FIG. 7 and FIG. 8 provides an overview of electrical hardware and suitable computing environments in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

FIG. 7 is a block diagram of an engine control computer 700 in which different implementations can be practiced. The engine control computer 700 includes a processor (such as a Pentium III processor from Intel Corp. in this example) which includes dynamic and static ram and non-volatile program read-only-memory (not shown), operating memory 704 (SDRAM in this example), communication ports 706 (e.g., RS-232 708 COM1/2 or Ethernet 710), and a data acquisition circuit 712 with analog inputs 714 and outputs and digital inputs and outputs 716.

In some implementations of the engine control computer 700, the data acquisition circuit 712 is also coupled to counter timer ports 740 and watchdog timer ports 742. In some implementations of the engine control computer 700, an RS-232 port 744 is coupled through a universal asynchronous receiver/transmitter (UART) 746 to a bridge 726.

In some implementations of the engine control computer 700, the Ethernet port 710 is coupled to the bus 728 through an Ethernet controller 750.

With proper digital amplifiers and analog signal conditioners, the engine control computer 700 can be programmed to drive coolant control gate valves, either in a predetermined sequence, or interactively modify coolant flow by opening and closing (or modulating) coolant control valve positions, in response to engine or coolant temperatures. The engine temperatures (or coolant temperatures) can be monitored by thermal sensors, the output of which, after passing through appropriate signal conditioners, can be read by the analog to digital converters that are part of the data acquisition circuit 712. Thus the coolant or engine temperatures can be made available as information that the coolant application program can operate on as part of its decision-making software that acts to modulate coolant valve position in order to maintain the proper coolant and engine temperature.

FIG. 8 is a block diagram of a data acquisition circuit 800 of an engine control computer in which different implementations can be practiced. The data acquisition circuit is one example of the data acquisition circuit 712 in FIG. 7 above. Some implementations of the data acquisition circuit 800 provide 16-bit A/D performance with input voltage capability up to +/−10V, and programmable input ranges.

The data acquisition circuit 800 can include a bus 802, such as a conventional PC/104 bus. The data acquisition circuit 800 can be operably coupled to a controller chip 804. Some implementations of the controller chip 804 include an analog/digital first-in/first-out (FIFO) buffer 806 that is operably coupled to controller logic 808. In some implementations of the data acquisition circuit 800, the FIFO 806 receives signal data from and analog/digital converter (ADC) 810, which exchanges signal data with a programmable gain amplifier 812, which receives data from a multiplexer 814, which receives signal data from analog inputs 816.

In some implementations of the data acquisition circuit 800, the controller logic 808 sends signal data to the ADC 810 and a digital/analog converter (DAC) 818. The DAC 818 sends signal data to analog outputs. The analog outputs, after proper amplification, can be used to modulate coolant valve actuator positions. In some implementations of the data acquisition circuit 800, the controller logic 808 receives signal data from an external trigger 822.

In some implementations of the data acquisition circuit 800, the controller chip 804 includes a digital input/output (I/O) component 838 that sends digital signal data to computer output ports.

In some implementations of the data acquisition circuit 800, the controller logic 808 sends signal data to the bus 802 via a control line 846 and an interrupt line 848. In some implementations of the data acquisition circuit 800, the controller logic 808 exchanges signal data to the bus 802 via a transceiver 850.

Some implementations of the data acquisition circuit 800 include 12-bit D/A channels, programmable digital I/O lines, and programmable counter/timers. Analog circuitry can be placed away from the high-speed digital logic to ensure low-noise performance for important implementations. Some implementations of the data acquisition circuit 800 are fully supported by operating systems that can include, but are not limited to, DOS™, Linux™, RTLinux™, QNX™, Windows 98/NT/2000/XP/CE™, Forth™, and VxWorks™ to simplify application development.

### Dual-Shell Implementations

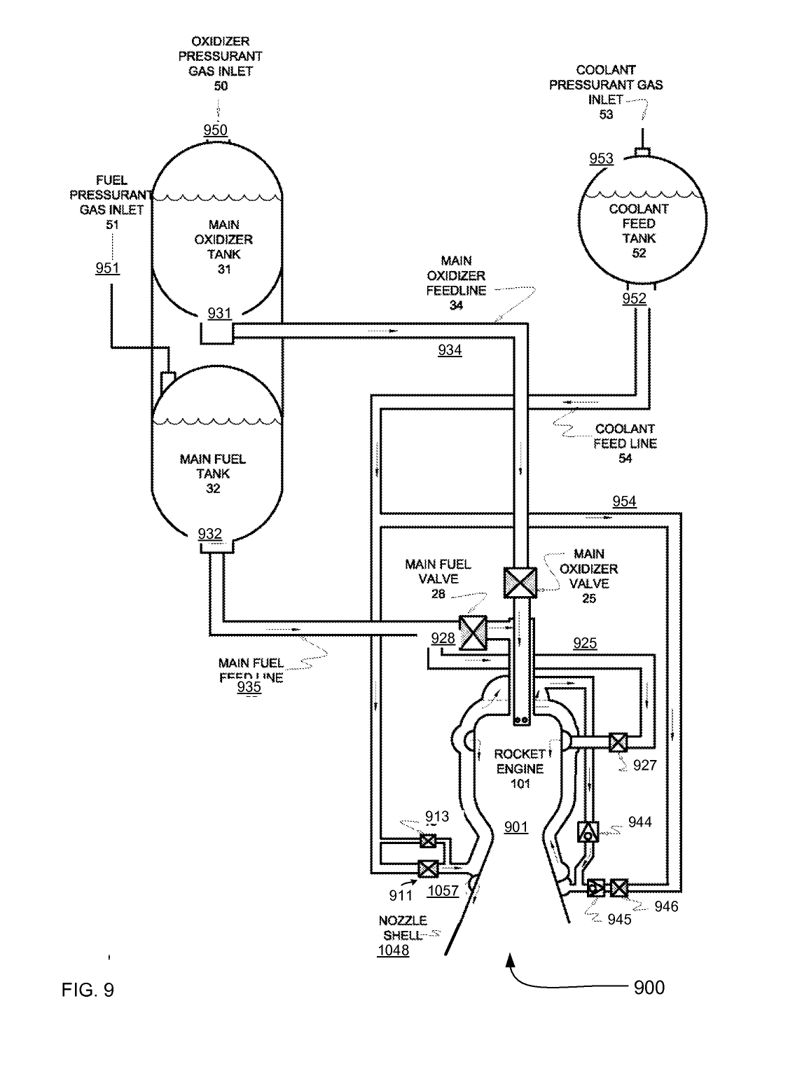

FIG. 9 and FIG. 10 show implementations of a cooling system. FIG. 9 and FIG. 10 are similar to the apparatus described in FIG. 1 and performs a process similar to the method in FIG. 6, but instead of flowing through a tube wrapped around a shell as described in apparatus in FIG. 1 and the method in FIG. 6, the external convective coolant 126 flows in a gap 1018 located between two shells, the outer shell 1007 and the inner shell 1006, that form the thrust chamber 102. After the external convective coolant 126 cools all or a portion of the thrust chamber by flowing through the gap 1018 the external convective coolant 126 then is either simply dumped overboard from the engine or is injected onto the expansion nozzle 108 interior wall 110 as a nozzle film coolant as shown in FIG. 10. FIG. 9 shows the external convective coolant 126 to be a fluid that is separate from the main propellants and has its own coolant feed tank 952 and plumbing although the external convective coolant 126 could be a main propellant fed off of one of the main propellant tanks The baseline coolant for this type of cooling system is water although any liquid, supercritical fluid, gas, boiling liquid, vapor, or other fluid can be used as coolant so long as the coolant absorbs the heat that is flowing through the inner shell 1006. Internal film coolant 120 is used in the thrust chamber 102 as a baseline with this system (e.g. jet fuel) although internal film coolant 120 is used in some implementations. The same conditions, methods, and options available to the FIG. 1-8 also apply to this dual-shell thrust chamber 102 configuration where helpful.

In some implementations, the external convective coolant 126 is injected from the gap 1018 from the nozzle film coolant manifold 1057 directly into the expansion nozzle 108 as nozzle film coolant. If the pressure in the gap 1018 is not high enough to collapse the inner shell 1006 prior to engine start (i.e. before the combustion chamber 106 pressure rises) then the external convective coolant 126 flow can be initiated prior to engine start. However, if thrust chambers where the gap 1018 operating pressure is higher than the collapse pressure of the inner shell 1006 prior to engine start, then the gap 1018 operating pressure (and therefore the external convective coolant flowrate 126) can be increased in such a way that the gap 1018 operating pressure is always less than the combustion chamber pressure in order to prevent inner shell 1006 collapse. In other words gap 1018 pressure rise will always lag combustion chamber 106 pressure rise or at least will be controlled such that the maximum pressure differential across the inner shell 1006 is always less than the pressure differential required to collapse the inner shell 1006. This usually means that the rise in gap 1018 pressure lags the rise in combustion chamber pressure 106 but this does not always have to be the case so long as the inner shell does not collapse 1006.

One possible problem with the gap pressure 1018 lagging the combustion chamber 106 pressure is that the external convective coolant 126 flowrate does not come up to its full operating flowrate until after the combustion chamber 16 pressure is at its full operating value. This will not pose a serious problem for the dual shell portion of the thrust chamber, but in some implementation the gap pressure 1018 lagging the combustion chamber 106 pressure will leave the nozzle shell 1048 deficient of enough nozzle film coolant during the engine start sequence. The thrust chamber 102 configuration shown in FIG. 9 and FIG. 10 alleviates this problem of nozzle shell 1048 cooling during engine startup. The thrust chamber 102 configuration shown in FIG. 9 and FIG. 10 includes a separate nozzle coolant valve 1046 for cooling the nozzle shell 1048 during engine startup as described in the paragraphs that follow.

The thrust chamber configuration in FIG. 9 and FIG. 10 is a design where the gap 1018 operating pressure would collapse the inner shell 1006 prior to engine start but not after engine start. In this example case the gap pressure rise lags the combustion chamber pressure rise. All implementations herein do not need to follow this approach so long as the differential pressure across the inner shell 1006 does not collapse the inner shell 1006. This is achieved by timing the opening of the coolant isolation valve 911 to synchronize with the rise in combustion chamber 106 pressure such that collapse of the inner shell 1006 does not occur.

In FIG. 9 and FIG. 10 the engine is started as follows: Before the engine start sequence is initiated, the gap 1018 is prefilled with external convective coolant 126 by opening the gap fill valve 1013 which is sized to allow the gap 1018 to fill without collapsing the inner shell 1006. When the gap 1018 is filled the gap fill valve 1013 is closed. Next the main oxidizer valve 925, the main fuel valve 928, the film coolant valve 1027, and the nozzle coolant valve 1046 are opened at the same time or nearly the same time. When the main oxidizer valve 925 and the main fuel valve 928 are opened, the main propellants (oxidizer and fuel) flow through the main propellant injector 114 and into the combustion chamber 106 when they are ignited to start the engine. After the main propellants are ignited the combustion chamber 106 pressure will start to climb to 300 psia (example pressure only). The opening of the film coolant valve 1027 and the nozzle coolant valve 1046 will start the flow of film coolant along the hot/interior walls 104, 110 of the inner shell 1006 and the nozzle shell 1048 and will provide thrust chamber 102 cooling during the engine start process before the external convective coolant 126 starts to flow.

Note: The nozzle film coolant 1049 as shown in FIG. 10 is a temporary film coolant that flows during the engine start process in order to cool the nozzle shell 1048 during startup. Once the gap 1018 pressure has achieved a high enough value and the external convective coolant 126 is of sufficient flowrate the nozzle check valve 1045 will close and the nozzle shell 1048 will then be cooled by the external convective coolant 126 which will act as a film coolant in the expansion nozzle 108. However, before the external convective coolant 126 comes up to full pressure and flowrate, the nozzle shell 1048 is cooled by the higher pressure nozzle film coolant 1049.)

A short time after the main propellants ignite and the combustion chamber pressure starts to increase (about a few milliseconds to a few tens of milliseconds after ignition) the coolant isolation valve 911 starts to open such that the difference between the maximum pressure in the gap 1018 and the combustion chamber pressure does not exceed the minimum collapse pressure of the inner shell 1006. For an example design, when both pressures achieve their steady state values, the combustion chamber 106 pressure can be 300 psia and the maximum gap 1018 pressure can be 265 psia, (pressure values are examples only) thus preventing collapse of the inner shell 1006. The function of the coolant check valve 1044 keeps the gap 1018 from being prematurely over pressurized from the nozzle film coolant 1049 during the engine start process. In some implementations, the nozzle coolant valve 1046 is closed at the same time as the coolant isolation valve 911 is opened, thus starting the flow of external convective coolant 126 while allowing no interruption in the film cooling of the nozzle shell 1048. If the gap pressure is ever allowed to exceed the combustion chamber pressure then the gap pressure will still not collapse the inner shell 1006.

As with the thrust chamber 102 baseline design of FIG. 1, the cooling system in FIG. 9 and FIG. 10 operates completely independent of the engine's main propellant injector 114. The unique features of this cooling system is that the valve arrangement and/or the use of an external convective coolant 126 or an internal film coolant 120 that is not one of the main propellants, and/or the dumping of the external convective coolant 126 into the atmosphere or injecting into the expansion nozzle 108 as film coolant. These features and/or combination of features allow the construction of a simplified and low cost shell structure thrust chamber 102. FIG. 9 and FIG. 10 are not limited to the features of the baseline design of FIG. 1. For instance FIG. 9 and FIG. 10 utilize liquid oxygen and jet fuel as the main propellants and water as the external convective coolant 126 while jet fuel is the internal film coolant 120 that is fed to the thrust chamber 102 by its own film coolant valve 1027. The thrust chamber 102 is an Inconel® alloy double shell structure with an inner shell 1006, an outer shell 1007, and a gap 1018 in between the two shells in which the water external convective coolant 126 flows to cool the thrust chamber 102. After cooling a portion or all of the thrust chamber 102 the external convective coolant 126 flowrate is ducted to the expansion nozzle 108 and is injected along the expansion nozzle Interior Wall 110 as the nozzle film coolant.

The nozzle shell 1048 portion of the expansion nozzle 108 structure is a single shell of (but not limited to) Inconel® alloy structure. The nozzle film coolant can be injected anywhere in the expansion nozzle 108 that the designer wishes but injecting it at an area ratio of 2 to 4 would be typical. The area ratio is the ratio the cross-sectional area of a particular location in the expansion nozzle 108 to the cross section area of the throat 122. The static pressure in the expansion nozzle 108 in the vicinity of where the nozzle film coolant is injected is usually on the order of 10-30 times less than the combustion chamber 106 operating pressure. Thus, injecting external convective coolant 126 into the expansion nozzle 108 allows the designer a large range of flexibility in setting the operating pressure of the gap 1018. The maximum operating pressure of the gap 1018 can be low (i.e. slightly higher than the local expansion nozzle 108 static pressure where the nozzle film coolant is injected into the nozzle). Such a lower gap 1018 operating pressure would allow for less buckling stress on the inner shell 1006 and would result in a lighter coolant feed tank 952 and less weight of coolant feed tank pressurizing gas that is required. The net result would be lighter cooling system hardware.

On the other hand, increasing the mean operating pressure of the gap 1018 would increase the boiling temperature (in the gap 1018) of a liquid external convective coolant 126 thus allowing the external convective coolant 126 to absorb more heat before massive boiling begins (sometimes called “film boiling”). The increase in heat absorption capacity of the external convective coolant 126 allows the reduction of external convective coolant flowrate needed to cool the thrust chamber 102 and also the total weight of external convective coolant 126 carried by a rocket vehicle. In any rocket vehicle, to achieve the optimal gross vehicle weight for maximum useful payload, there is a tradeoff between cooling system hardware inert weight and external convective coolant 126 total weight. Injecting external convective coolant into the expansion nozzle 108 as nozzle film coolant allows the designer maximum flexibility is selecting the gap 1018 maximum operating pressure (and thus its mean and minimum operating pressures) to the optimal value that allows a rocket vehicle to carry the most useful payload.

In the baseline design and the design of FIG. 9 and FIG. 10 the engine is a pressure-fed rocket engine with an example combustion chamber 106 operating pressure of 300 psia and a maximum gap 1018 operating pressure of 265 psia. The internal film coolant 120 is jet fuel and has a flowrate equal to 3.7% of the total fluid flowrate to the combustion chamber 106 (includes the main propellants and the Internal Film Coolant). The external convective coolant 126 is water and has a flowrate into the expansion nozzle 108 equal to 2.9% of the total fluid flow to the entire thrust chamber 102 (includes the main propellants, internal film coolant, and nozzle film coolant). The operating pressure of the gap 1018 may or may not be enough to collapse the inner shell 1006 prior to start of the engine (i.e. when the combustion chamber 106 pressure rises to 300 psia). The minimum collapse pressure of the inner shell 1006 depends on the inner shell 1006 thickness, its material of construction, the physical size of the thrust chamber 102, and the inner Shell's maximum operating temperature. However, for the design configuration of FIG. 9 and FIG. 10 the maximum gap 1018 operating pressure is enough to collapse the inner shell 1006 prior to the combustion chamber operating pressure rising to 300 psia. In such a case the engine valves (including the main propellant valves) will be controlled and timed to allow the rise of gap 1018 pressure to slightly lag the rise of combustion chamber pressure (for example a lag of a few milliseconds to a few tens of milliseconds) in such a way that the difference in the gap pressure and the combustion chamber pressure is never great enough to cause the Inner shell 1006 to collapse. This allows the inner shell 1006 to be thinner, lighter, and to run at a lower maximum temperature on its hot wall 104 surface on the inside of the thrust chamber 102.

As with the baseline design herein, any features, traits, and values of the double-shell thrust chamber 102 described herein are for example only and the actual features, traits, and values can vary. For a dual-shell thrust chamber 102 the reduction in static pressure in the expansion nozzle 108 after engine start should be accounted for in the thrust chamber design to prevent collapse of the inner shell 1006.

### CONCLUSION

An economical liquid-fueled propulsion system is described. A technical result of the system is sufficiently high thrust from a propulsion system that is economical to manufacture. Although specific implementations are illustrated and described herein, it will be appreciated by those of ordinary skill in the art that any arrangement which is calculated to achieve the same purpose can be substituted for the specific implementations shown. This disclosure is intended to cover any adaptations or variations.

The systems, methods and apparatus described herein a low-cost rocket engine technology that can be used to produce rocket engines of a wide range of thrust sizes or propellant combinations for private, commercial, or government aerospace programs. The economical engine systems, methods and apparatus described herein will increase the confidence of these organizations in obtaining rocket engines at greatly reduced cost and procurement times. In addition, the economical systems, methods and apparatus described herein reduce the procurement lead time of rocket engines and the procurement costs. The systems, methods and apparatus described herein provide faster and cheaper development and reproduction of rocket engines of a wide range of thrust sizes or propellant combinations (i.e. combination of fuel and oxidizer).

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to different thrust chambers 102, inside walls 104, combustion chambers 106, expansion nozzles 108, expansion nozzle interiors 110, thrust chamber exteriors 112, main propellant injectors 114, oxidizers 116, fuels 118, internal film coolants 120, coolant tube(s) 124, external convective coolants 126, internal film coolant manifolds 410, and nozzle film coolant manifolds 1057.

The terminology used in this disclosure includes injectors, fuel, thrust chambers and alternate technologies which provide the same functionality as described herein

1-26. (canceled)

27. A method to cool a rocket engine, the method comprising:
injecting an internal film coolant along at least a portion of the interior hot wall of a thrust chamber of a rocket engine; and
injecting at least a portion of an external convective coolant along at least a portion of the interior hot wall of the thrust chamber of the rocket engine,
wherein at least one of the two coolants is not a main propellant.

28. The method of claim 27, wherein injecting at least a portion of the external convective coolant further comprises:
injecting at least a portion of the external convective coolant along an interior wall of an expansion nozzle of the thrust chamber.

29. The method of claim 27, wherein the internal film coolant is not the external convective coolant.

30. The method of claim 27 wherein the thrust chamber further comprises:
a thrust chamber structure constructed of materials such as metals, metal alloys, metal compounds, metal composites, plastics, plastic composites, and composite materials.

31. The method of claim 27 wherein at least a portion of the thrust chamber further comprises:
a simple shell thrust chamber construction.

32. The method of claim 27, wherein the method further comprises:
flowing the external convective coolant on at least a portion of the exterior wall of the combustion chamber shell; and
flowing the external convective coolant on at least a portion of the exterior wall of the shell comprising the throat of the rocket engine; and
flowing the external convective coolant on at least a portion of the exterior wall of the expansion nozzle shell of the rocket engine.

33. The method of claim 6 wherein flowing the external convective coolant further comprises:
flowing the external convective coolant through at least one coolant tube mounted to the exterior wall of at least a portion of the thrust chamber shell.

34. The method of claim 6, wherein flowing the external convective coolant further comprises:
circulating the external convective coolant around at least a portion of the thrust chamber shell.

35. The method of claim 27, wherein the external convective coolant further comprises:
not a main propellant and not the internal film coolant.

36. The method of claim 27, wherein the internal film coolant is in a range of about 1% to about 10% of the total of the internal film coolant and the external convective coolant and the plurality of main propellants.

37. The method of claim 27, wherein the external convective coolant is about 1% to about 10% of the total of the internal film coolant and the external convective coolant and the plurality of main propellants.

38. The method of claim 27 further comprising:
operating at least one coolant tube independently of a main propellant injector; and
an external convective coolant flows through at least one external coolant tube.

39. The method of claim 27, wherein the internal film coolant is about 3.5% of the total of the internal film coolant and the external convective coolant and the plurality of main propellants and wherein the external convective coolant is about 2.75% of the total of the internal film coolant and the external convective coolant and the plurality of main propellants.

40. The method of claim 6, wherein the thrust chamber shell further comprises:
a wall having a thickness of between about 0.010 inches and about 0.50 inches, wherein the thickness does not include thickness of any ribs or other hardware formed into or secured onto the thrust chamber shell.

41. The method of claim 6 further comprising:
not more than one tube mounted to the outside of the thrust chamber shell that is operable to flow within itself the external convective coolant.

42. The method of claim 27, wherein at least a portion of the thrust chamber is a double shell thin metal structure further comprising an inner shell and an outer shell with external convective coolant cooling at least a portion of the thrust chamber by flowing in a gap between the two shells; and
wherein the internal film coolant further comprises about 1-10% of the total of the internal film coolant and the external convective coolant and the plurality of main propellants; and
wherein the external convective coolant is between about 1-10% of the total of the internal film coolant and the external convective coolant and the plurality of main propellants.

43. The method of claim 42 where each of the inner and outer shells further comprise a thickness between about 0.010 inches to 0.50 inches, wherein the thickness does not include thickness of any ribs, spacers, or other hardware formed into or secured onto the inner and outer shells.

44. The method of claim 42, wherein after flowing in a gap between the double shells at least a portion of the external convective coolant is injected along an interior wall of at least a portion of the expansion nozzle.

45. The method of claim 42 wherein the opening and closing of a coolant isolation valve is controlled/timed to control the fluid pressure in a gap wherein the difference in pressure between a gap and the interior of the thrust chamber is insufficient to cause a collapse of the inner shell.

46. The method of claim 42 wherein during rocket engine startup a temporary nozzle film coolant is fed into and injected along the inside wall of the expansion nozzle and cools at least a portion of the expansion nozzle until the external convective coolant in a gap builds up to sufficient pressure and flowrate to begin cooling the portion of the expansion nozzle.

47. The method of claim 42 wherein at least a portion of the thrust chamber structure is comprising of solid items in the gap or formed into the inner and outer shells as necessary to maintain the gap or to attach the shells together as necessary; and;
wherein the thickness of these solid items being in addition to the thickness of the inner and outer shells.
